(19) United States
(12) Patent Application Publication
(10) Pub. No.: US 2016/0140877 A1
(43) Pub. Date: May 19, 2016

(54) Human Body Museum and System for Touring Within

(71) Applicant: Jimin Qi, Vancouver (CA)

(72) Inventor: Jimin Qi, Vancouver (CA)

(21) Appl. No.: 14/543,779

(22) Filed: Nov. 17, 2014

(51) Int. Cl. G09B 23/30

(52) U.S. Cl. CPC G09B 23/30

(57) ABSTRACT

The present invention includes a museum system having a structure configured in size, shape and proportion to a human body, a Tour-Ball constructed and arranged to receive at least one person into an interior cavity therein, wherein the travel ball having at least one information display associated therewith, whereby said display is configured to receive location information of said ball, and the museum having devices constructed and arranged to move said ball throughout said museum.

### BACKGROUND OF THE INVENTION

Many museum displays have greatly enhanced the museum-goers knowledge and experience relating to the human body. However, many of these are deficient in that they lack certain aspects relating to the experience of touring the body. The present invention addresses this by providing a museum system whereby a museum-goer can tour the human body and view the inside components in anatomically correct ratios.

### SUMMARY OF THE INVENTION

This invention relates to magnified museum mannequins. In one embodiment, the invention is a magnified adult pregnant woman model and in one embodiment, a magnified adult male model. The position and the size of the magnified human bodies depend on the real conditions, such as the size of the venue when they are built. The available options for posture are supine pregnant female and sitting male or supine male and sitting pregnant female. The available magnification is seen in Table 1. The magnified human bodies are simulated by systems, such as circulatory system, respiratory system, digestive system, urinary system, reproductive system, nervous system, endocrine system, lymphatic system, sensory organs and musculoskeletal system in total ten systems.

Table 1, below is demonstrative, but not limiting, of contemplated ratios and relationships according to the current invention.

TABLE 1

| Female, | | Height | male. | | Height |
|---|---|---|---|---|---|
| 160 cm | | on | 170 cm | | on |
| Magnifi- | Supine | Chair | Magnifi- | Supine | Chair |
| cation | (m) | (m) | cation | (m) | (m) |
| ×10 = | 16 | 13.3 | ×10 = | 17 | 14.1 |
| ×20 = | 32 | 26.6 | ×20 = | 34 | 28.2 |
| ×50 = | 80 | 66.3 | ×50 = | 85 | 70.6 |
| ×100 = | 160 | 133 | ×100 = | 170 | 141 |
| ×200 = | 320 | 266 | ×200 = | 340 | 282 |
| ×500 = | 800 | 663 | ×500:; | 850 | 106 |
| ×1,000 = | 1,600 | 1,328 | ×1,000 = | 1,700 | 1,410 |
| ×2,000 = | 3,200 | 2,660 | ×2,000 = | 3,400 | 2,820 |
| ×5,000 = | 8,000 | 6,630 | ×5,000 = | 8,500 | 7,060 |
| ×10,000; | 16,000 | 1,3280 | )(10,000 = | :1′7,000 | 14,lOO |
| ×20,000 = | 32,000 | 6,6300 | ×20,000 = | 34,000 | 28,200 |

The magnified human bodies allow visitors to enter, travel, and study inside by taking a specific travel tool: Tour-Ball. They are also available to be installed some devices, such as computers, monitors, large screens by which can play the human anatomy, physiology, pathology, disease manifestations, diagnosis, treatment, prognosis, prevention and so on In one embodiment, an adult pregnant woman has height 160 cm, supine position, and two palms upward and enlarged 10,000 times, compared to 16,000 meters in length. The female model includes systems proportional to the organs, tissues, cells, and other components etc. enlarged 10,000 times, allowing visitors to tour inside by taking Tour-Balls.

For example, normal red blood cells having a diameter of (6-9) μm are amplified 10,000 fold: (6-9) μm×10,000=(60,000−90,000) μm=6-9 cm (visible); Normal stomach (25×30) cm, enlarged to 10,000 fold as: (25×30) cm×10,000=(2,500×3,000) m; Normal left atria diameter: male 30 mm and female 25 mm; enlarged to 10,000 fold: male 300 m and female 250 m; Normal uterus: (3×5×7) cm; amplified 500 times: (3×5×7) cm×500 =(15×25×35) m.

The wall of all hollow organs (such as the heart, blood vessels, respiratory tract, lung, gastrointestinal tract, gall bladder, ureter, bladder, urethra, fallopian tubes, uterus vagina, etc.) is made of transparent material. Visitors sitting in the Tour-Ball can see everything around them and watch the adjacent organs through the transparent wall. Of course, the visitors in the Tour-Ball can also see each other. All visitors sitting in the Tour-Ball can enter other different organs through the capillary network.

Each organ is built in accordance with its own normal morphology amplification and there are also corresponding pathological specimens inside. Inside each internal organ is equipped with computers, monitors and screens, which consistently display videos related to the corresponding organs of common diseases and their causes, pathology, clinical presentation, diagnosis, treatment, prognosis and prevention measures. Visitors can pause, watch and study the medical knowledge and health prevention knowledge at any organ, and think about the mysteries of human body structure and function, particularly praise the creator of humanity.

Visitors must ride on a Tour-Ball in order to tour inside. Visitors can drive the Tour-Ball themselves or let it move automatically like simulated real blood cells moving. During the tour process in the human body, visitors are not allowed to leave the Tour-Ball.

Visitors may start their tour from anyone of the following entries: mouth, noses, ears, anus, urethra or vagina. For example, visitors can enter the body model through the vagina of women and learn about anatomy, physiology, pathology, as well as pregnancy and childbirth of women.

A complete trip in the magnified human body model can be done in the circulatory system. For example, it starts from the capillary network, small veins, veins, large veins, heart, aorta, arteries, small arteries, arterioles to capillaries network completing. Visitors can cross through the microcirculation into other systems such as the respiratory system, digestive system, urinary system, reproductive system, and sensory organs in any part of the capillary network at any time. The Tour-Balls can reach every organ, such as brain, eyes, ears, nose, mouth, heart, lungs, liver, spleen, kidney, stomach, intestines, pancreas, and gallbladder and so on.

The Tour-Ball can be moved within the respiratory system, from the nose, nasal cavity, pharynx, upper respiratory tract, lower respiratory tract, the main bronchus, left and right bronchi, bronchioles, and finally to the alveoli. The Tour-Ball can enter and leave the circulatory system via the pulmonary capillary network. The Tour-Ball can be moved within the digestive system, from the mouth, esophagus, stomach, empty field, ileum, colon, rectum and anus, including moving in bile duct, pancreatic duct, etc. The Tour-Ball can enter and leave the circulatory system via the capillary network of the digestive system. The Tour-Ball can be moved within the urinary system, from the urethra, bladder, ureter, and renal pelvis to renal calyces. The Tour-Ball can enter and leave the circulatory system via the capillary network of the urinary system. The Tour-Ball can be moved within the female reproductive system, from the vagina, uterus, and fallopian tubes to the ovaries. Tour-Ball can enter and leave the circulatory system via the capillary network of the female reproductive system.

The Tour-Balls in different systems have different colors and shapes based on the anatomical and physiological features of the system. They may be shaped like a biconcave red blood cell or like a spherical white blood cell. In addition, the shape of the Tour-Balls can also change during movement, particularly while they pass through the capillary wall. The Tour-Ball with transparent walls and diameter, for example, 100 cm can take up to three people in each. Visitors can observe everything around them, through the transparent walls, while sitting and moving. The Tour-Balls in the genitourinary system can be designed to compare with sperm or egg shape.

The movement speed of the Tour-Ball is designed of the movement normal speed of red and white blood cells.

In one embodiment, an adult male, height 170 cm, magnified 500 times, the height of 850 m; sitting height of 706 m (FIG. 7). Visitors can explore the magnified male body model by taking Tour-Balls.

For magnified man, there is only built his internal male genitourinary system, such as pelvis, penis and testicles. That means only part of the body, male pelvic structures, is to be built. The rest of the body structures will not repeat as same as part of the female body. The rest space of the body, including abdominal, chest, neck and head and legs, and feet part, are constructed as hotels, restaurants, shopping malls, conference rooms or entertainment, etc. in order to provide other services.

In another embodiment, an adult pregnant female, length 160 cm, magnified 500 times, the length of 800 m; so sitting height of 663 m.

In one embodiment, the magnified woman has female urogenital system with a fetus and two-breast structure. The rest of the body structures will not repeat as same as part of the male body. Beyond the breasts and pelvic, such as abdominal, chest, neck, head, legs and feet, are constructed as hotels, restaurants, shopping malls, conference rooms or entertainment, etc. in order to provide other services.

Also contemplated is the person in said Tour Ball being provided with an electronic device, including hand-held computer/tablet and other micro computing hand-held devices, displaying a digital game stored on a non-transitory computer readable medium either on the display device, or transmitted to the display device based on human anatomy and physiology, wherein said electronic device synchronizes questions based on at least one of current location of the Tour Ball, proximate location either forward or reverse, within previous 10-120 seconds, user selected location, or combinations thereof.

### BRIEF DESCRIPTION OF THE SEVERAL VIEWS OF THE DRAWING

FIG. 1 is a side perspective view of the Human Anatomy Museum of the present invention in a supine position.

FIG. 2 is one embodiment of the Human Anatomy Museum of the present invention in a sitting position.

FIG. 3 is one embodiment of the present invention demonstrating entrance into the museum through a typical organ orifice, in this embodiment being entrance through the ear orifice.

FIG. 4 is a planned view of one embodiment of the present invention of the Tour-Ball vehicle utilized.

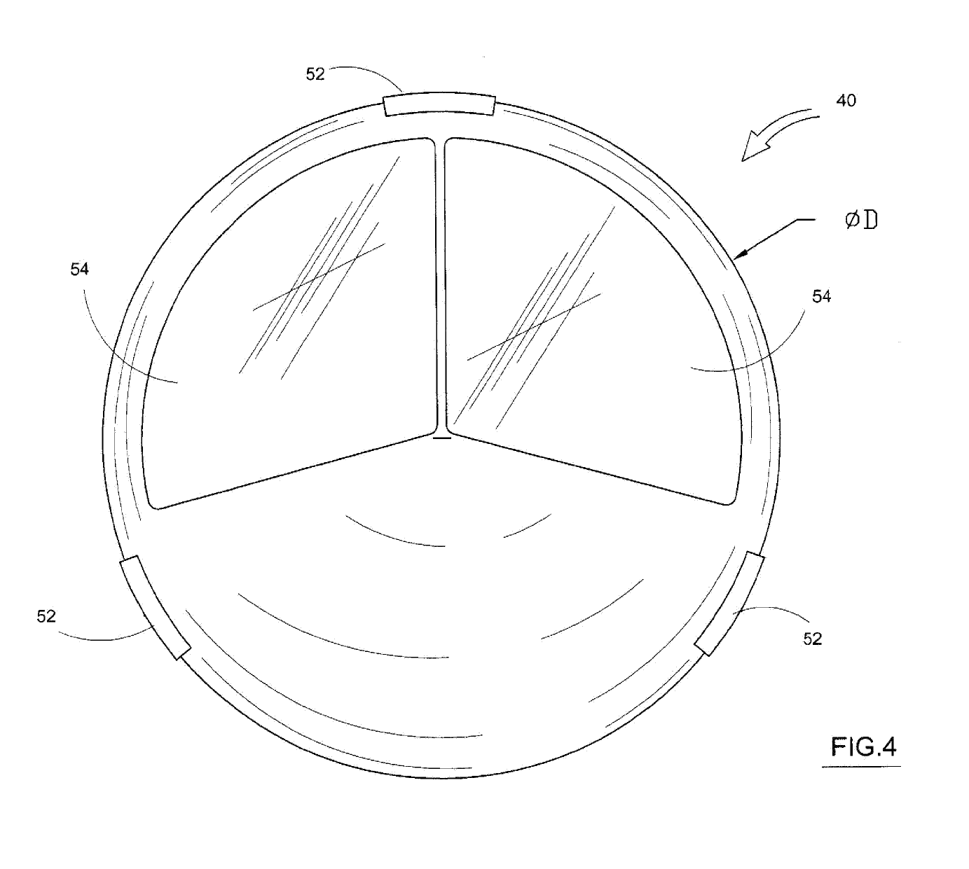

FIG. 5 is a front sectional view demonstrating persons sitting within the Tour-Ball vehicle of one embodiment of the present invention.

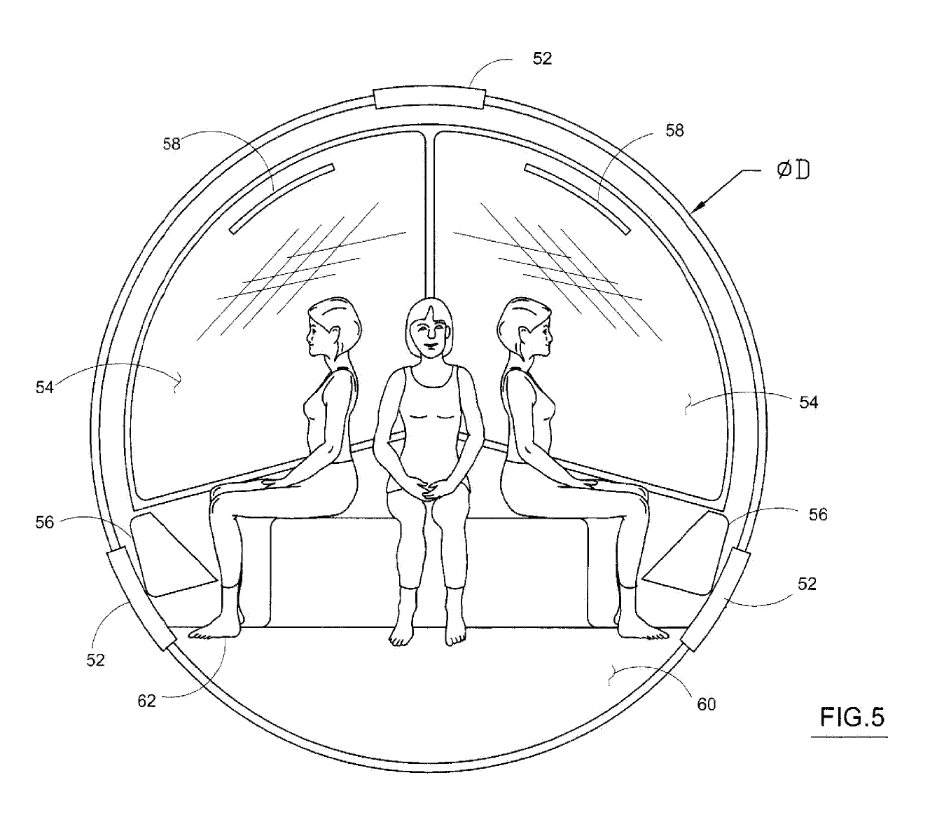

FIG. 6 is a sectional view of Tour-Balls operating in a simulated artery according to one embodiment of the present invention.

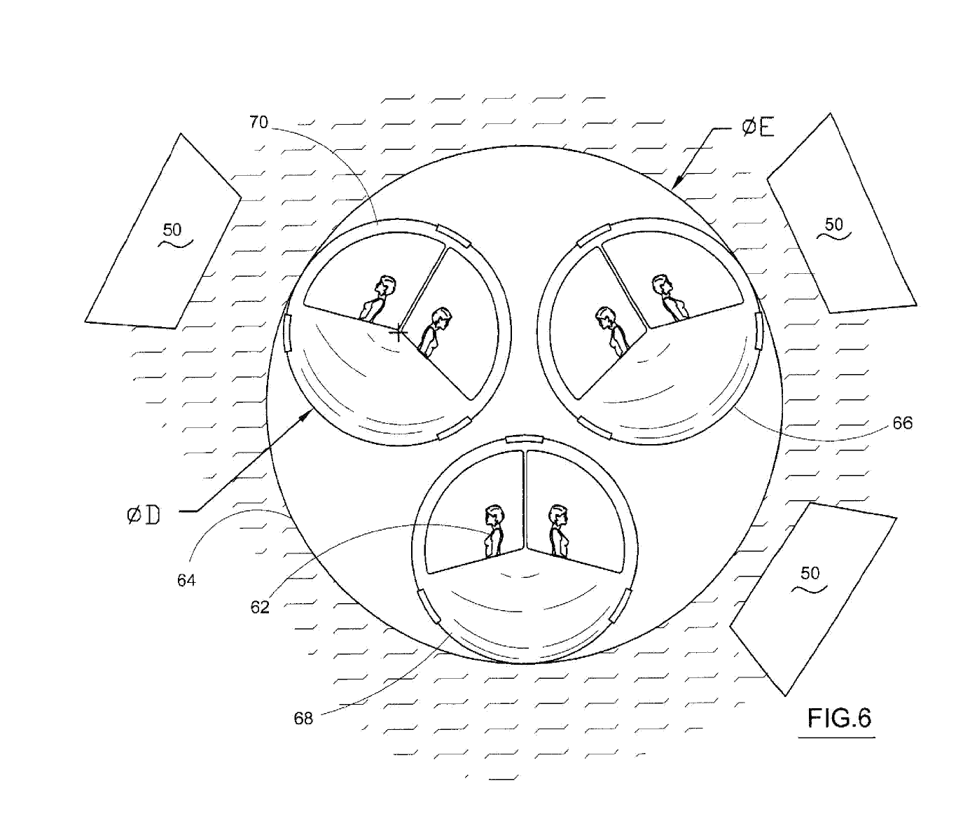

### DETAILED DESCRIPTION OF THE PREFERRED EMBODIMENT

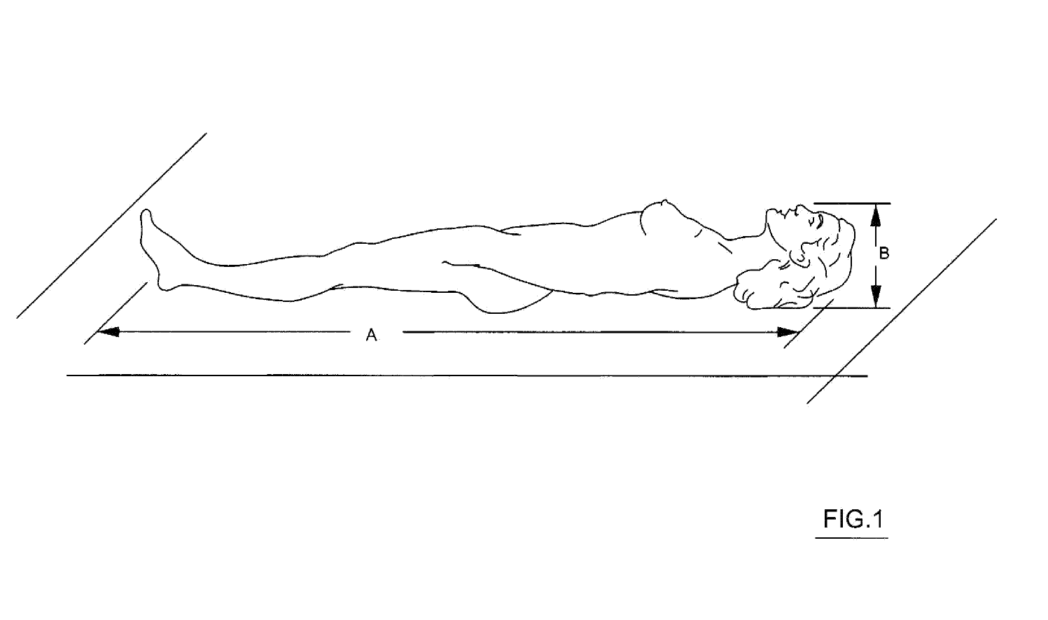

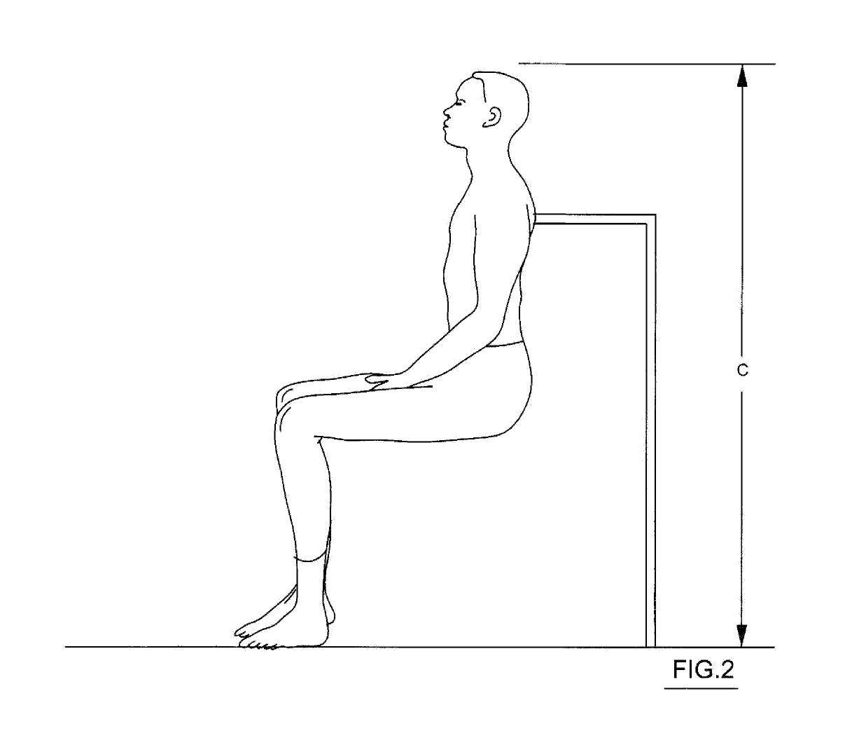

The present invention relates to an expanded, anatomically correct human body museum whereby visitors tour through the body in a touring vehicle. In one embodiment, as demonstrated in FIG. 1, museum 10 is a person lying in a supine position. In another embodiment, as demonstrated in FIG. 2, the museum is configured as a human body in the sitting position. Although there are museum displays that purport to demonstrate the interior of a human body to viewers, the present invention provides a unique perspective in that a plurality of Tour-Ball vehicles 40 are provided whereby the vehicles travel through the various components of a human body whereby all components are presented to scale. The museum is configured with at least one entrance and exit constructed and arranged to accommodate the Tour-Balls 40.

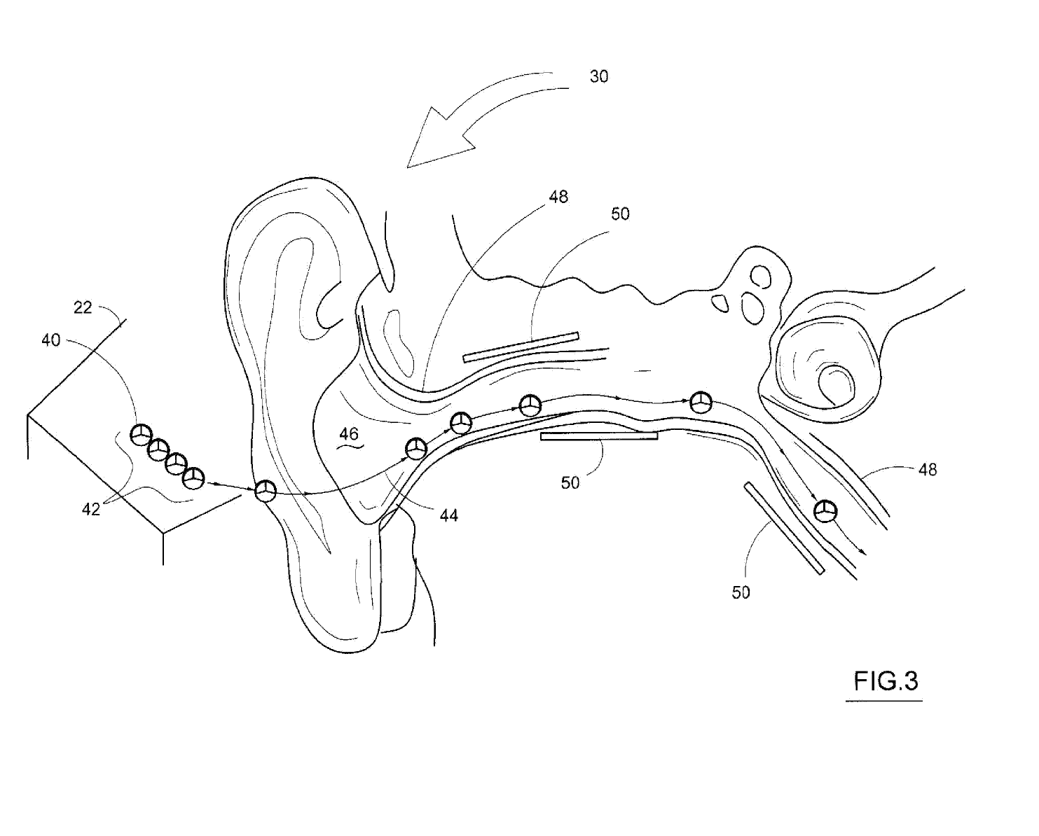

In one embodiment, as demonstrated in FIG. 3, the entrance is through the ear orifice. Although the figures demonstrate entrance and exit through an ear orifice, it is contemplated that any one or more commonly known body entrance pathways are contemplated configured for entrance and/or exit according to the present invention. This includes, but would not be limited to, nostrils, mouth, anus, combinations thereof and the like. Tour-Balls 40 (also known as travel balls) is presented in a queue 42 for persons to enter the ball and subsequently enter the museum through an entrance 30. Entrance configuration 30 includes entrance path 44 leading to ear canal 46. Ear canal 46 will include transparent and/or translucent wall structures 48 such that persons in Tour-Ball 40 can observe the interior anatomy of the museum.

A video display 50 is positioned along the path 44 traveled by Tour-Ball 40 as it travels through the museum. In one embodiment, Tour-Ball 40 has one or more transparent windows 54 configured in the structure such that visitors riding inside Tour-Ball 40 can see their surroundings. In one embodiment, one or more magnetic motion modules 52 are associated with Tour-Ball 40 and are constructed and arranged to interact with magnetic motion controls positioned throughout the museum. Inside Tour-Ball 40 are a control interface module 56, communication screens 58, and motion control devices 60. A museum traveler 62 will be seated within Tour-Ball 40 as Tour-Ball 40 progresses throughout the museum.

In one embodiment, each Tour-Ball 40 proceeds throughout the body and balls are configured to travel through artery 64 while museum patrons 62 view interior structures and video displays 50 throughout the system. Although exact configurations are varied depending on design selections, it is contemplated that all interior structures of the museum of the present invention be displayed in anatomically correct ratios. In one embodiment, Tour-Ball 40 has a diameter of between 1.3 and 2.5 meters. In one preferred embodiment, the diameter of Tour-Ball 40 is between 1.3 and 1.5 meters. In one embodiment, Tour-Balls 40 is moved throughout the museum with magnet drives in order to facilitate control of patrons throughout the museum. Although one contemplated embodiment of the present invention includes magnet drive technology, other technologies are contemplated, including drone control technology, rails, tracks, other mechanical means of movement, combinations thereof and the like. Additionally, the present invention is not limited to any one particular mode of locomotion and contemplated using one mode or, in one embodiment, a combination of locomotion modes.

In one embodiment, the user will be able to select one or more anatomical systems to explore and will be directed in their individualized Tour-Ball 40 to that particular system or systems. In another embodiment, a central control monitors movement of all Tour-Balls 40 within the museum and controls all movement. In one embodiment, a visitor will take a tour specifically of one system. For example, a visitor may enter the nostrils and be a tour of the nasal pharyngeal cavity. In another embodiment, a visitor may enter the mouth and take a tour of the entire digestive system. These are given by illustration only and not meant to limit the interior configuration.

In one embodiment, it is contemplated the museum of the present invention be 16,000 meters from head to toe. This would provide a scale of 1:160. In another embodiment, the museum is configured of a person 2,000 meters head to toe. This would be a scale of 1:20.

In one embodiment, video screens 58 within Tour-Ball 40 are constructed and arranged with receiving devices such that when Tour-Ball 40 passes a particularized location inside the museum, appropriate video is displayed inside of Tour-Ball 40. For example, when Tour-Ball 40 enters the heart, appropriate video and information are provided to persons within Tour-Ball 40.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

What is claimed is:

1. A museum system comprising: a structure configured in size, shape and proportion to a human body; a Tour-Ball constructed and arranged to receive at least one person into an interior cavity therein; said travel ball having at least one information display associated therewith, whereby said display is configured to receive location information of said ball; said museum having devices constructed and arranged to move said ball throughout said museum.

2. The museum of claim 1 having at least one opening configured for providing an entrance and exit fro said Tour-Ball.

3. The museum of claim 1 having at least one control panel configured for directing movement of said ball.

4. The museum of claim 1 wherein said Tour-Ball route is directed on a route controlled by a person within said ball.

5. The museum of claim 1 wherein said Tour-Ball is moved by at least one of motorized wheels, electronic rails, magnetic rails, or combinations thereof.

6. The museum of claim 1 wherein said interior cavity of said Tour-Ball selectively outputs information relative to a current or upcoming anatomical position of said ball.

7. The museum of claim 1 including a plurality of Tour-Balls moving simultaneously or with near simultaneity throughout said museum.

8. The museum of claim 1 wherein anatomical features are presented with detail similar to actual human anatomical components.

9. The museum of claim 1 wherein anatomical features move in a manner similar to actual human anatomical components.

10. The museum of claim 1 wherein a person in said Tour-Ball is provided with an actuator to initiate movement of a selected anatomical component.

11. The museum of claim 1 wherein said person in said Tour Ball is provided with an electronic device displaying a digital game based on human anatomy and physiology, wherein said electronic device synchronizes questions based on at least one of current location of the Tour Ball, proximate location either forward or reverse, within previous 10-120 seconds, user selected location, or combinations thereof.
